(19) United States
(12) Patent Application Publication
(10) Pub. No.: US 2025/0336032 A1
(43) Pub. Date: Oct. 30, 2025

(54) ELECTRONIC DEVICE AND CONTROL METHOD THEREOF

(71) Applicant: SAMSUNG ELECTRONICS CO., LTD., Suwon-si (KR)

(72) Inventors: Soungmin YOO, Suwon-si (KR); Yongwoo Shin, Suwon-si (KR)

(73) Assignee: SAMSUNG ELECTRONICS CO., LTD., Suwon-si (KR)

(21) Appl. No.: 19/262,964

(22) Filed: Jul. 8, 2025

Related U.S. Application Data
(63) Continuation of application No. PCT/KR2023/020511, filed on Dec. 13, 2023.

(30) Foreign Application Priority Data
Feb. 9, 2023 (KR) 10-2023-0017445

(51) Int. Cl. G06T 3/40

(52) U.S. Cl. CPC G06T 3/40; G06T 2200/24

(57) ABSTRACT

An electronic device includes a display; memory storing instructions; and a processor, wherein the instructions, when executed, cause the electronic device to display a screen including a first area including content and a second area including a margin; based on a third area including a portion of the content to be enlarged being selected in the first area, identify a fourth area adjacent to the third area in the second area; identify whether the third area with an enlarged size is displayable within the fourth area; based on identifying that the enlarged third area is displayable within the fourth area, display the enlarged third area in the fourth area; and based on identifying that the enlarged third area is not displayable within the fourth area, display the enlarged third area in at least a partial area of the third area and at least a partial area of the fourth area.

### CROSS-REFERENCE TO RELATED APPLICATIONS

This application is a by-pass continuation application of International Application No. PCT/KR2023/020511, filed on Dec. 13, 2023, which is based on and claims priority to Korean Patent Application No. 10-2023-0017445, filed on Feb. 9, 2023, in the Korean Intellectual Property Office, the disclosures of which are incorporated by reference herein in their entireties.

### BACKGROUND

### 1. Field

The disclosure relates to an electronic device and a control method thereof, and to an electronic device that enlarges a displayed content according to a user instruction and provides the enlarged content, and a control method thereof.

### 2. Description of Related Art

Fueled by the development of electronic technologies, various types of electronic devices are being developed and distributed. Development and distribution of display devices such as a TV or a mobile device, for example, are actively being researched.

As a part of more diverse display functions, a function of enlarging and displaying a part of a content displayed on a display is being provided.

### SUMMARY

According to an aspect of the disclosure, an electronic device includes a display; memory storing at least one instruction; and at least one processor, wherein the at least one instruction, when executed by the at least one processor individually or collectively, causes the electronic device to control the display to display a screen including a first area including content and a second area including a margin other than the content; based on a third area including a portion of the content to be enlarged and displayed being selected in the first area, identify a fourth area adjacent to the third area in the second area; identify whether the third area with an enlarged size is displayable within the fourth area; based on identifying that the third area with the enlarged size is displayable within the fourth area, control the display such that the third area with the enlarged size is displayed in the fourth area; and based on identifying that the third area with the enlarged size is not displayable within the fourth area, control the display such that the third area with the enlarged size is displayed in at least a partial area of the third area and at least a partial area of the fourth area.

The at least one instruction, when executed by the at least one processor individually or collectively, may cause the electronic device to, based on identifying that the third area with the enlarged size is not displayable within (i) the fourth area, and is not displayable in (ii) at least the partial area of the third area, and (iii) at least the partial area of the fourth area,: identify a fifth area not adjacent to the third area in the second area; identify whether the third area with the enlarged size is displayable within the identified fifth area; and based on identifying that the third area with the enlarged size is displayable within the fifth area, move the first area to the direction of the fifth area, and control the display to display the third area with the enlarged size within the fourth area with an enlarged size as the first area moved.

The at least one instruction, when executed by the at least one processor individually or collectively, may cause the electronic device to, based on identifying, that the third area with the enlarged size is not displayable within the fifth area, and based on identifying that the third area with the enlarged size is displayable in at least a partial area of the fourth area with the enlarged size as the first area is moved and at least the partial area of the third area, move the first area to the direction of the fifth area, and control the display to display the third area with the enlarged size in at least the partial area of the fourth area with the enlarged size as the first area moved and at least the partial area of the third area.

The at least one instruction, when executed by the at least one processor individually or collectively, may cause the electronic device to, based on identifying that the third area with the enlarged size is not displayable within the fourth area, and based on identifying that the third area with the enlarged size is not displayable in at least a partial area of the fourth area with the enlarged size as the first area is moved by moving the first area to the direction of the fifth area and at least the partial area of the third area, control the display to provide a user interface (UI) for selecting at least one from among an enlarged size and a display area of the third area; and control the display to display the third area with the enlarged size based on a user selection via the UI.

The third area may be a rectangular area having a predetermined ratio between dimensions, and the third area with the enlarged size may maintain the predetermined ratio between dimensions.

The at least one instruction, when executed by the at least one processor individually or collectively, may cause the electronic device to, based on identifying that the third area with the enlarged size is displayable within the fourth area, display the third area with the enlarged size in the fourth area such that a center of the third area with the enlarged size is aligned with a center of the third area included in the first area.

The at least one instruction, when executed by the at least one processor individually or collectively, may cause the electronic device to, based on identifying that the third area with the enlarged size is not displayable within the fourth area, control the display such that the third area with the enlarged size is displayed to extend from the third area within the first area to at least the partial area of the fourth area.

The at least one instruction, when executed by the at least one processor individually or collectively, may cause the electronic device to, based on a plurality of third areas being selected in the first area—wherein portions of the content to be enlarged and displayed are included among the plurality of third areas—identify a plurality of fourth areas adjacent to the plurality of third areas in the second area; and control the display to display the plurality of third areas with enlarged sizes within the plurality of fourth areas.

According to an aspect of the disclosure, a control method of an electronic device includes displaying a screen including a first area including a content and a second area including a margin other than the content; based on a third area including a portion of the content to be enlarged and displayed being selected in the first area, identifying a fourth area adjacent to the third area in the second area; identifying whether the third area with an enlarged size is displayable within the fourth area; based on identifying that the third area with the enlarged size is displayable within the fourth area, displaying the third area with the enlarged size in the fourth area; and based on identifying that the third area with the enlarged size is not displayable within the fourth area, displaying the third area with the enlarged size in at least a partial area of the third area and at least a partial area of the fourth area.

The control method may further include, based on identifying that the third area with the enlarged size is not displayable within (i) the fourth area, (ii) at least the partial area of the third area, and (iii) at least the partial area of the fourth area, identifying a fifth area not adjacent to the third area in the second area; identifying whether the third area with the enlarged size is displayable within the fifth area; and based on identifying that the third area with the enlarged size is displayable within the fifth area, moving the first area to the direction of the fifth area, and displaying the third area with the enlarged size within the fourth area with an enlarged size as the first area moved.

The control method may further include, based on identifying, as the first area is moved, that (i) the third area with the enlarged size is not displayable within the fifth area, and (ii) the third area with the enlarged size is displayable in at least a partial area of the fifth area and at least the partial area of the third area, moving the first area to the direction of the fifth area, and displaying the third area with the enlarged size in at least the partial area of the fourth area with the enlarged size as the first area moved and at least the partial area of the third area.

The control method may further include, based on identifying, as the first area is moved, that (i) the third area with the enlarged size is not displayable within the fourth area, and (ii) the third area with the enlarged size is not displayable in at least a partial area of the fifth area and at least the partial area of the third area, providing a user interface (UI) for selecting at least one from among the enlarged size and a display area of the third area; and displaying the third area with the enlarged size based on a user selection via the UI.

The third area may be a rectangular area having a predetermined ratio between dimensions, and the third area with the enlarged size may maintain the predetermined ratio between dimensions.

The displaying the third area with the enlarged size in the fourth area may include, based on identifying that the third area with the enlarged size is displayable within the fourth area, displaying the third area with the enlarged size in the fourth area such that a center of the third area with the enlarged size is aligned with a center of the third area included in the first area.

According to an aspect of the disclosure, a non-transitory computer-readable medium having at least one instruction recorded thereon, that, when executed by at least one processor individually or collectively, causes the at least one processor to display a screen including a first area including a content and a second area including a margin other than the content; based on a third area including a portion of the content to be enlarged and displayed being selected in the first area, identify a fourth area adjacent to the third area in the second area; identify whether the third area with an enlarged size is displayable within the fourth area; based on identifying that the third area with the enlarged size is displayable within the fourth area, display the third area with the enlarged size in the fourth area; and based on identifying that the third area with the enlarged size is not displayable within the fourth area, display the third area with the enlarged size in at least a partial area of the third area and at least a partial area of the fourth area.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 is a diagram for illustrating an example wherein a portion of a content displayed on a screen is enlarged and displayed according to an embodiment of the disclosure;

FIG. 2 is a block diagram illustrating a configuration of an electronic device according to an embodiment of the disclosure;

FIG. 3A and FIG. 3B are flow charts for illustrating a method of enlarging and displaying a portion of a content according to an embodiment of the disclosure;

FIG. 4A, 4B, 4C, 5A, 5B, 5C, 6A, 6B, 6C, 7A, 7B, 7C, 8A and 8B are diagrams for illustrating a method of enlarging and displaying a portion of a content according to a margin of a display screen according to an embodiment of the disclosure;

FIG. 9 is a block diagram illustrating a detailed configuration of an electronic device according to an embodiment of the disclosure; and

FIG. 10 is a flow chart for illustrating a control method of an electronic device according to an embodiment of the disclosure.

### DETAILED DESCRIPTION

The embodiments described in the disclosure, and the configurations shown in the drawings, are only examples of embodiments, and various modifications may be made without departing from the scope and spirit of the disclosure.

The embodiments described below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

The terms used in the disclosure are used only to explain embodiments, and are not intended to limit the scope of the disclosure. Singular expressions include plural expressions, unless defined differently.

Expressions such as “have,” “may have,” “include,” and “may include” denote the existence of such characteristics (e.g.: elements such as numbers, functions, operations, and components), and do not exclude the existence of additional characteristics.

The expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including at least one A, (2) including at least one B, or (3) including at least one A and at least one B.

The expressions “first,” “second,” and the like used in the disclosure may describe various elements regardless of any order and/or degree of importance. Such expressions are used only to distinguish one element from another element, and are not intended to limit the elements.

The description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

In contrast, the description that one element (e.g.: a first element) is “directly coupled” or “directly connected” to another element (e.g.: a second element) can be interpreted to mean that still another element (e.g.: a third element) does not exist between the one element and the another element.

The expression “configured to” used in the disclosure may be interchangeably used with other expressions such as “suitable for,” “having the capacity to,” “designed to,” “adapted to,” “made to,” and “capable of,” depending on cases. The term “configured to” may not necessarily mean that a device is “specifically designed to” in terms of hardware.

Instead, under some circumstances, the expression “a device configured to” may mean that the device “is capable of” performing an operation together with another device or component. For example, the phrase “a processor configured to perform A, B, and C” may mean a dedicated processor (e.g.: an embedded processor) for performing the corresponding operations, or a CPU or an application processor, for example, that can perform the corresponding operations by executing one or more software programs stored in a memory device.

In the embodiments of the disclosure, ‘a module’ or ‘a unit’ may perform at least one function or operation, and may be implemented as hardware or software, or as a combination of hardware and software. A plurality of ‘modules’ or ‘units’ may be integrated into at least one module and implemented as at least one processor, excluding ‘a module’ or ‘a unit’ that is indicated to be implemented with hardware.

Various elements and areas in the drawings were illustrated schematically. The technical idea of the disclosure is not limited by the relative sizes or intervals illustrated in the accompanying drawings.

The embodiments according to the disclosure will be described in detail with reference to the accompanying drawings, such that those having ordinary skill in the art to which the disclosure belongs can carry out the disclosure.

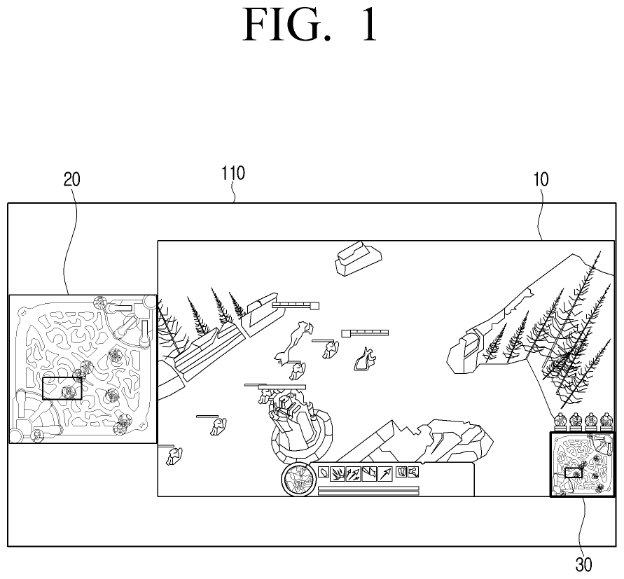

FIG. 1 is a diagram for illustrating an example wherein a portion of a content displayed on a screen is enlarged and displayed according to an embodiment of the disclosure

According to the embodiment illustrated in FIG. 1, a content screen 10 may be displayed in a partial area of a screen of a display 110. Here, a content provided on the content screen 10 may include a game content, a TV program, and other media contents, for example.

As the content screen 10 is displayed in a partial area of the display 110, a margin area may be provided in the other area of the display 110 wherein the content screen 10 is not displayed. According to an embodiment, in case an aspect ratio of the screen of the display 110 and an aspect ratio of a content are different, or in case the size and/or the aspect ratio, for example, of the content screen 10 was adjusted according to a user instruction, the content screen 10 may be displayed only in a partial area of the screen of the display 110, and the other area may be provided as a margin area.

A location wherein the margin area is provided may be changed according to the location of the content screen 10 displayed on the display 110. For example, in case a content is located on the right side of the screen of the display 110 as in FIG. 1, the margin area may be provided on the upper side, the lower side, and the left side of the content. The size of the margin area can be changed according to the size of the content screen 10 displayed on the display 110.

According to an embodiment, a partial area of a content provided on the content screen 10 may be enlarged and displayed on the display 110 according to a predetermined event. For example, if the third area 30 is selected, an enlarged area 20 corresponding to the third area 30 may be displayed in a margin area of the display 110. The degree that the partial area of the content is enlarged (or an enlargement ratio) and a location wherein the enlarged content is provided may be determined based on the size and/or the location of the margin area, or selected by a user input.

In case an enlarged content area is provided while being distanced from a content area which is a subject for enlargement as illustrated in FIG. 1, the user's gaze may be dispersed.

Various embodiments of providing an enlarged content area in a location close to a content area which is a subject for enlargement will be explained.

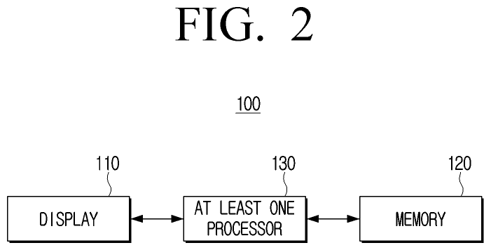

FIG. 2 is a block diagram illustrating a configuration of an electronic device according to an embodiment of the disclosure.

Referring to FIG. 2, the electronic device 100 may include a display 110, memory 120, and at least one processor 130. The components of the electronic device 100 illustrated in FIG. 2 are exemplary, and other components can be added.

The display 110 may display various types of information related to operations of the electronic device 100. For this, the display 110 may include various types of display panels such as a liquid crystal display (LCD) panel, an organic light-emitting diodes (OLED) panel, active-matrix organic light-emitting diodes (AM-OLED), liquid crystal on silicon (LcoS), quantum dot light-emitting diodes (QLED) and digital light processing (DLP), a plasma display panel (PDP), an inorganic LED panel, a micro LED panel, for example, but is not limited thereto. The display 110 may constitute a touch screen together with a touch panel, or consist of a flexible panel. According to an embodiment, the display 110 may be implemented as a flat display, a curved display, a flexible display that can be folded and/or rolled, for example.

The memory 120 may store data for various embodiments. The memory 120 may be implemented in a form of memory embedded in the electronic device 100, or implemented in a form of memory that can be attached to or detached from the electronic device 100 according to the use of stored data. For example, in the case of data for driving the electronic device 100, the data may be stored in memory embedded in the electronic device 100, and in the case of data for an extended function of the electronic device 100, the data may be stored in memory that can be attached to or detached from the electronic device 100. In the case of memory embedded in the electronic device 100, the memory may be implemented as at least one of volatile memory (dynamic RAM (DRAM), static RAM (SRAM), or synchronous dynamic RAM (SDRAM), for example) or non-volatile memory (e.g.: one time programmable ROM (OTPROM), programmable ROM (PROM), erasable and programmable ROM (EPROM), electrically erasable and programmable ROM (EEPROM), mask ROM, flash ROM, flash memory (NAND flash or NOR flash, for example), a hard drive, or a solid state drive (SSD)). In the case of memory that can be attached to or detached from the electronic device 100, the memory may be implemented in forms such as a memory card (compact flash (CF), secure digital (SD), micro secure digital (Micro-SD), mini secure digital (Mini-SD), extreme digital (xD), or a multi-media card (MMC), for example) and external memory that can be connected to a USB port (e.g., a USB memory), for example

The at least one processor 130 controls the overall operations of the electronic device 100. The at least one processor 130 may be connected with each component of the electronic device 100, and control the overall operations of the electronic device 100. For example, the at least one processor 130 may be electrically connected with the display 110 and the memory 120, and control the overall operations of the electronic device 100. The processor 130 may consist of one or a plurality of processors.

The at least one processor 130 may perform the operations of the electronic device 100 according to various embodiments by executing the at least one instruction stored in the memory 120.

The at least one processor 130 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor 130 may control one or a random combination of the other components of the electronic device 100, and perform an operation related to communication or data processing. The at least one processor 130 may execute one or more programs or instructions stored in the memory. For example, the at least one processor 130 may perform the method according to an embodiment of the disclosure by executing the one or more instructions stored in the memory.

In case the method according to an embodiment includes a plurality of operations, the plurality of operations may be performed by one processor, or performed by a plurality of processors. For example, when a first operation, a second operation, and a third operation are performed by the method according to an embodiment, all of the first operation, the second operation, and the third operation may be performed by a first processor, or the first operation and the second operation may be performed by the first processor (e.g., aCPU), and the third operation may be performed by a second processor (e.g., an artificial intelligence-dedicated processor).

The at least one processor 130 may be implemented as a single core processor including one core, or may be implemented as one or more multicore processors including a plurality of cores (e.g., multicores of the same kind or multicores of different kinds). In case the at least one processor 130 is implemented as multicore processors, each of the plurality of cores included in the multicore processors may include internal memory of the processor such as cache memory, on-chip memory, for example, and common cache shared by the plurality of cores may be included in the multicore processors. Each of the plurality of cores (or some of the plurality of cores) included in the multicore processors may independently read a program instruction for implementing the method according to an embodiment of the disclosure and perform the instruction, or the plurality of entire cores (or some of the cores) may be linked with one another, and read a program instruction for implementing the method according to an embodiment of the disclosure and perform the instruction.

In the embodiments of the disclosure, the processor may mean a system on chip (SoC) wherein at least one processor and other electronic components are integrated, a single core processor, a multicore processor, or a core included in the single core processor or the multicore processor. Here, the core may be implemented as a CPU, a GPU, an APU, a MIC, a DSP, an NPU, a hardware accelerator, or a machine learning accelerator, for example, but the embodiments of the disclosure are not limited thereto. The at least one processor 130 will be referred to as the processor 130, for the convenience of explanation.

According to an embodiment, the processor 130 may control the display 110 to display a screen including a first area including a content and a second area including a margin other than the content. According to an embodiment, in case an aspect ratio of the display 110 and an aspect ratio of a content are different, or in case the size and/or the aspect ratio, for example, of the content screen 10 was adjusted according to a user instruction, for example, the content screen 10 may be displayed only in a partial area of the screen of the display 110, and the other area may be provided as a margin area.

If a third area including a portion of the content to be enlarged and displayed is selected in the first area, the processor 130 may identify a fourth area adjacent to the third area in the second area. For example, the processor 130 may identify a fourth area adjacent to the selected partial area of the content in the margin area. Here, the adjacent area may not only mean a margin area wherein the fourth area is adjacent to the third area without an interval, but also a margin area that is closest to the third area even if it is distanced from the third area.

The processor 130 may identify whether the third area with an enlarged size is displayable within the identified fourth area. Here, the feature of being displayable may mean that the entire third area with the enlarged size is displayed to be included within the fourth area. Here, the enlarged size of the third area may be determined according to the size of the margin area, a user selection, a default size, for example.

Afterwards, if it is identified that the third area with the enlarged size is displayable within the fourth area, the processor 130 may control the display 110 such that the third area with the enlarged size is displayed in the fourth area.

If it is identified that the third area with the enlarged size is not displayable within the fourth area, the processor 130 may control the display 110 such that the third area with the enlarged size is displayed in at least a partial area of the third area and at least a partial area of the fourth area.

If it is identified that the third area with the enlarged size is not displayable within the fourth area, and is not displayable in at least the partial area of the third area and at least the partial area of the fourth area, the processor 130 may identify a fifth area not adjacent to the third area in the second area.

The processor 130 may identify whether the third area with the enlarged size is displayable within the identified fifth area.

If it is identified that the third area with the enlarged size is displayable within the fifth area, the processor 130 may move the first area to the direction of the fifth area, and control the display 110 to display the third area with the enlarged size within the fourth area with an enlarged size as the first area moved.

If it is identified that the third area with the enlarged size is not displayable within the fifth area, the processor 130 may move the first area in the direction of the fifth area, and control the display 110 to display the third area with the enlarged size in at least a partial area of the fourth area with the enlarged size as the first area moved and at least the partial area of the third area.

In case it is identified that the third area with the enlarged size is not displayable within the fourth area, and the fifth area that is not adjacent to the third area is not identified in the second area, the processor 130 may control the display 110 to provide a UI for selecting at least one of the enlarged size or a display area of the third area.

The processor 130 may control the display 110 to display the third area with the enlarged size based on at least one of the enlarged size or the display area of the third area selected through the UI.

If it is identified that the third area with the enlarged size is not displayable within the fourth area, the processor 130 may control the display 110 such that the third area with the enlarged size is enlarged in a form of extending from the third area within the first area to at least the partial area of the fourth area, and is displayed.

If a plurality of third areas respectively including a portion of the content to be enlarged and displayed are selected in the first area, the processor 130 may identify a plurality of fourth areas adjacent to each of the plurality of third areas in the second area.

The processor 130 may control the display 110 to display each of the plurality of third areas with the enlarged sizes within the plurality of identified fourth areas. According to an embodiment, the third area may be a rectangular area having a predetermined ratio, and the third area with the enlarged size may be an area that was enlarged while the predetermined ratio is maintained. The disclosure is not limited thereto, and the third area may be selected as various forms such as a polygon, a circle, and any drawing area.

If it is identified that the third area with the enlarged size is displayable within the fourth area, the processor 130 may display the third area with the enlarged size in the fourth area such that the center of the third area with the enlarged size is aligned with the center of the third area included in the first area.

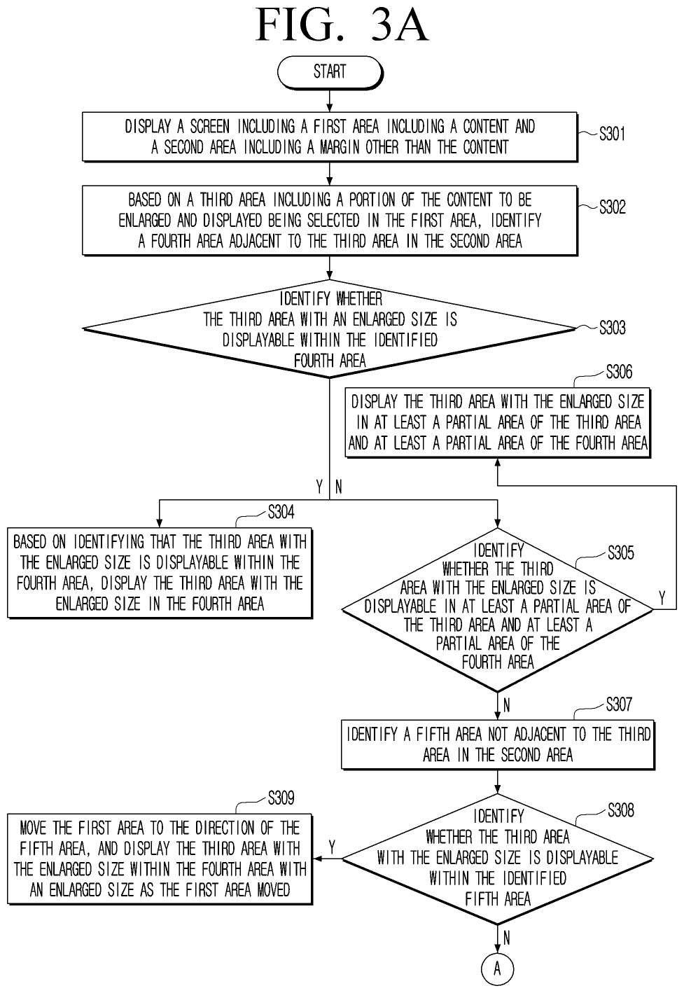

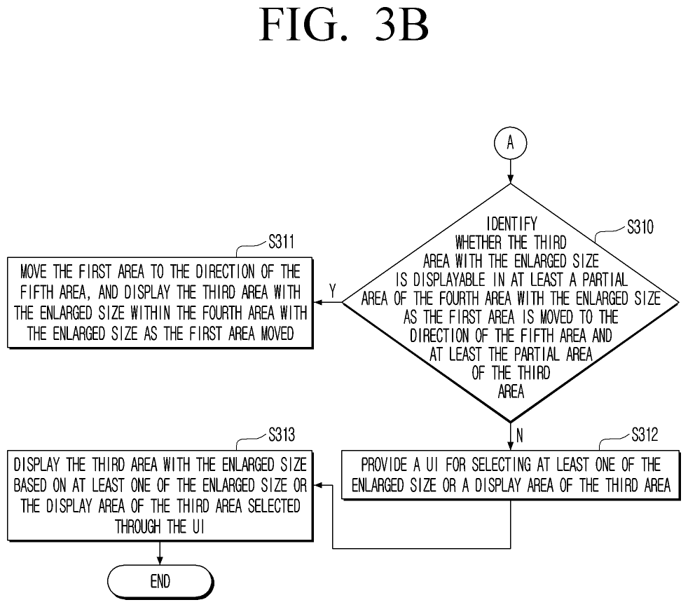

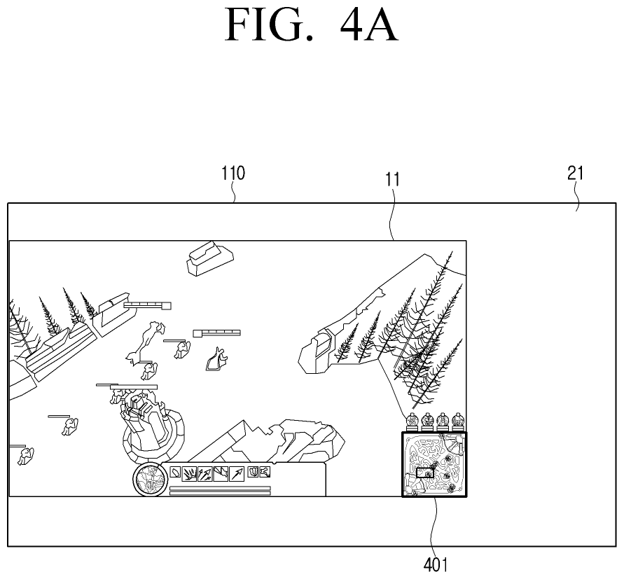

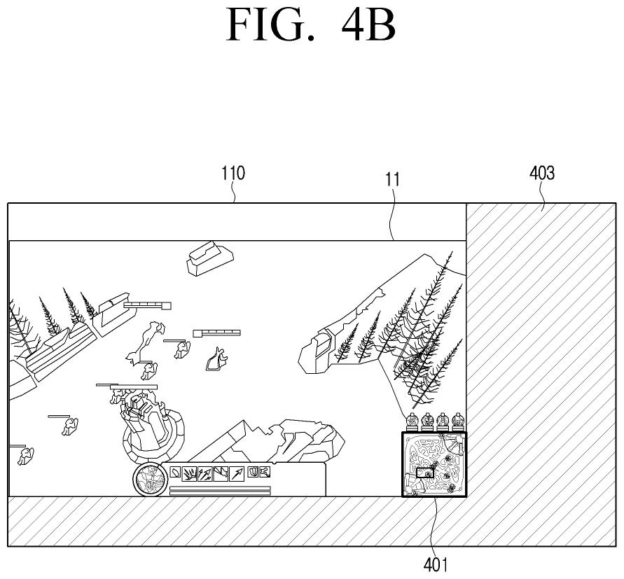

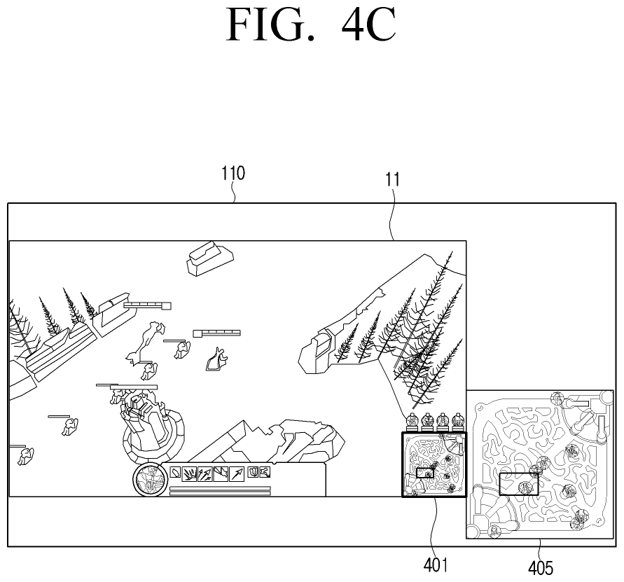

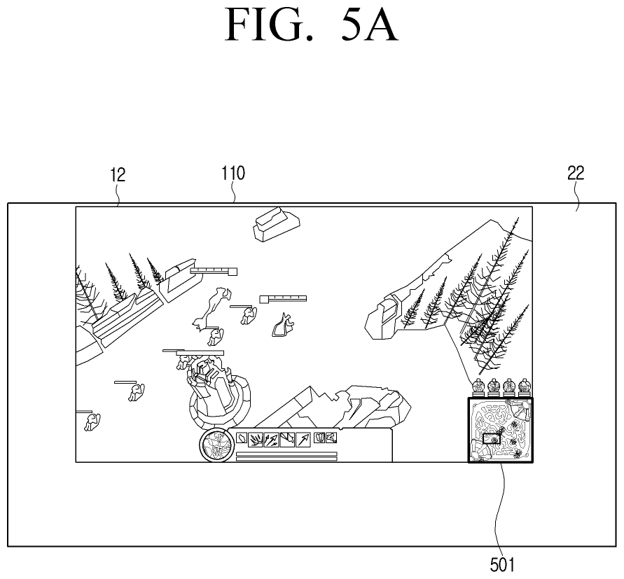

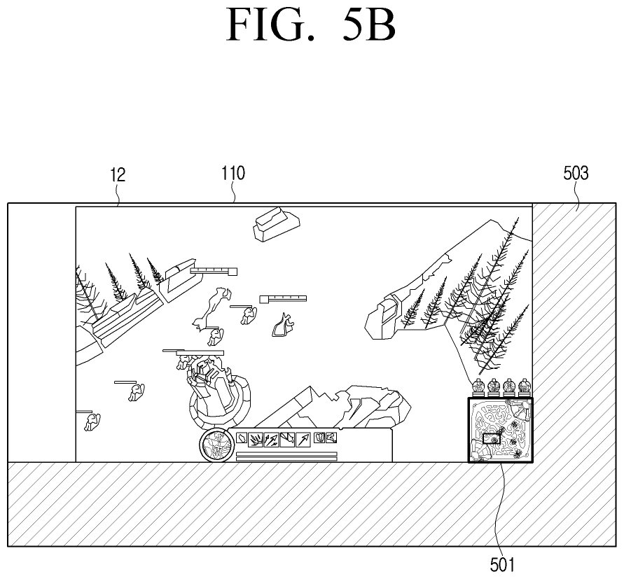

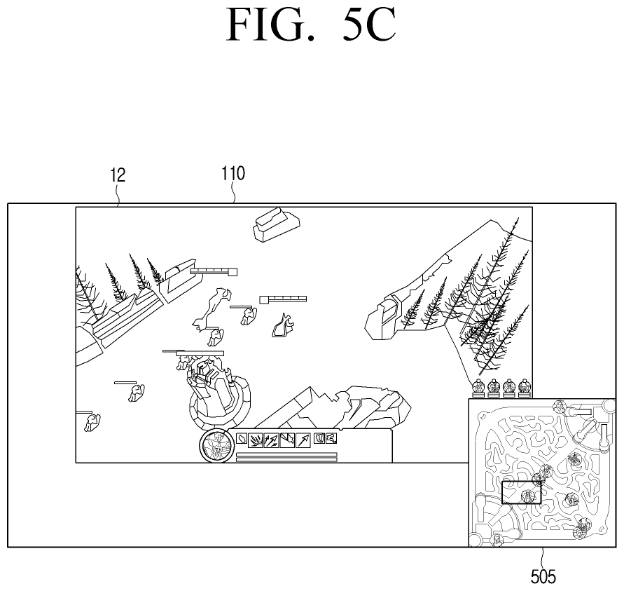

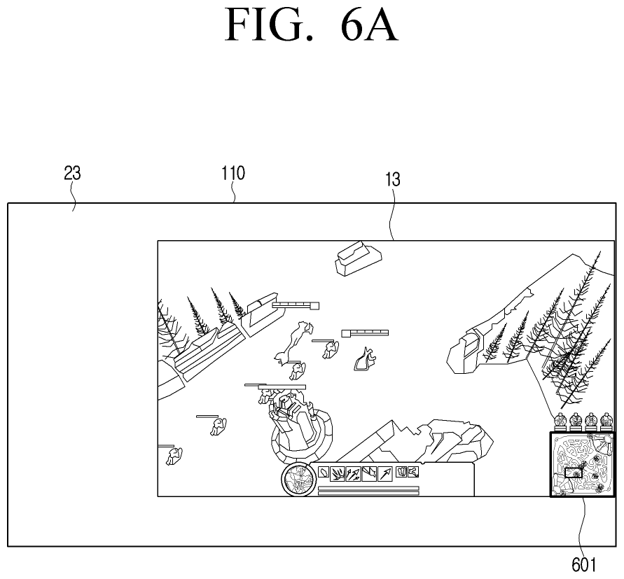

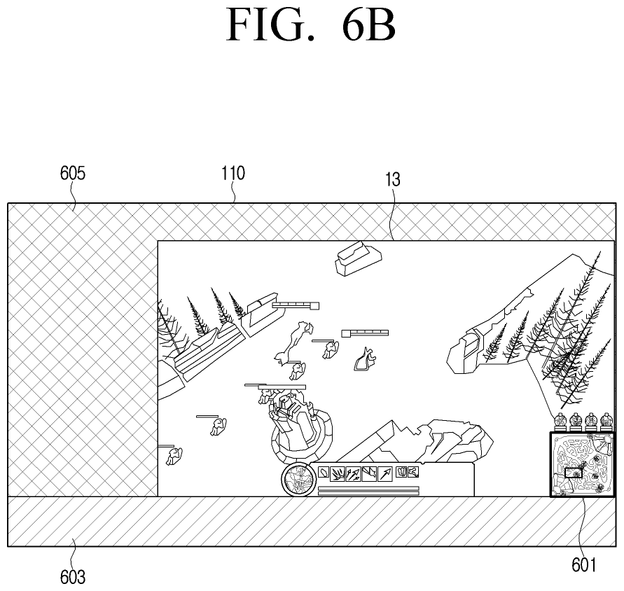

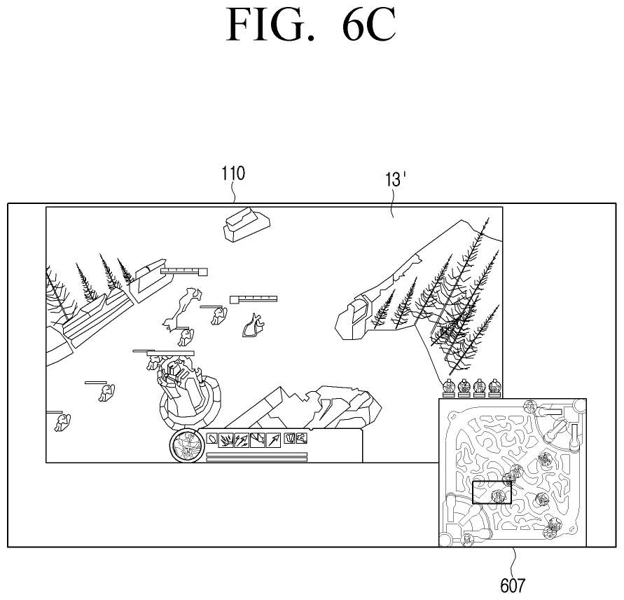

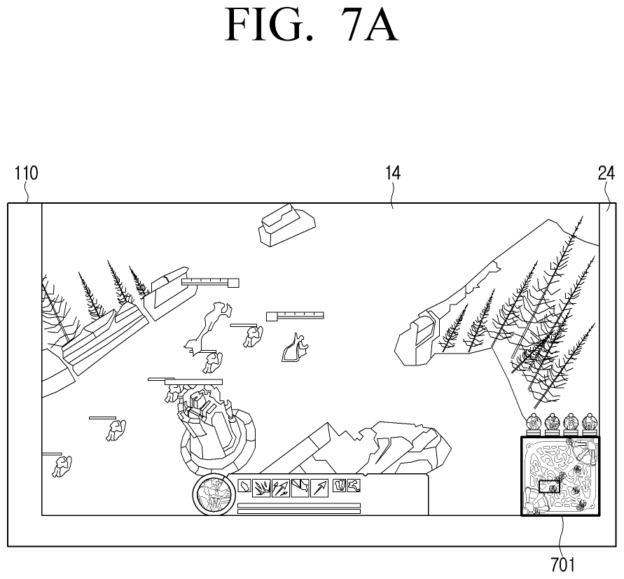

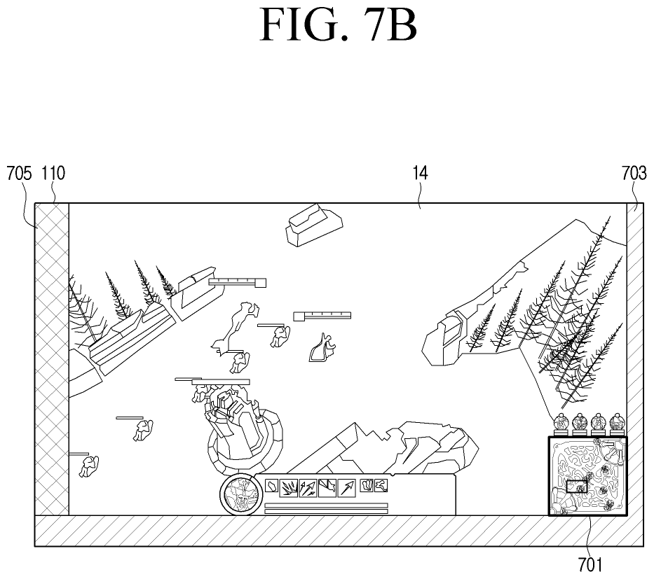

FIG. 3A and FIG. 3B are flow charts for illustrating a method of enlarging and displaying a portion of a content according to an embodiment of the disclosure. In explaining FIG. 3A and FIG. 3B, a method of enlarging and displaying a portion of a content will be explained with reference to FIG. 4 to FIG. 8.

The processor 130 may control the display 110 to display a screen including a first area including a content and a second area including a margin other than the content in the step S301.

For example, referring to FIG. 4A, the processor 130 may control the display 110 to display a first area 11 including a content and a second area 21 corresponding to a margin area wherein the content is not displayed.

If a third area including a portion of the content to be enlarged and displayed is selected in the first area, the processor 130 may identify a fourth area adjacent to the third area in the second area in the step S302. Here, the portion of the content to be enlarged and displayed may be a portion of the content included in the first area. The selected third area may be in a form of a polygon such as a rectangle, a triangle, or a circle, for example, having a predetermined ratio, and in a form of any drawing area.

For example, referring to FIG. 4A, a third area 401 corresponding to a portion of the first area 11 may be selected by a user input in the first area 11 including a content. Here, the user input may be a predetermined manipulation input for the third area 401, but is not limited thereto. For example, in a case wherein a pointer is located on the third area 401 during a predetermined time or longer, for example, the area is selected as an enlarged area.

When the third area is selected, the processor 130 may identify a fourth area adjacent to the third area in the second area. For example, the processor 130 may identify a fourth area 403 adjacent to the third area 401 in the second area 21 wherein the content is not displayed. For example, as in FIG. 4B, in case a part wherein the third area 401 and the second area 21 are adjacent is the margin on the right side and the lower side of the display 110, the processor 130 may identify the margin on the right side and the lower side of the display 110 as the fourth area 403. In case there is no part wherein the third area is adjacent to the second area, the processor 130 may identify an area closest to the third area in the second area as the fourth area.

The processor 130 may identify whether the third area with an enlarged size is displayable within the identified fourth area in the step S303. Here, the third area with the enlarged size may be an area that was enlarged while a predetermined ratio is maintained, or may be of a size that was enlarged to a size corresponding to at least one length from among the horizontal length and/or the vertical length of the area wherein the third area is included in the fourth area.

In case the size of the third area with the enlarged size can be included within the fourth area 403, the processor 130 may identify that the third area with the enlarged size can be displayed in the fourth area 403. In case at least one of the horizontal length or the vertical length of the fourth area is identical to or smaller than at least one of the horizontal length or the vertical length of the third area, the processor 130 may identify that the third area with the enlarged size cannot be displayed in the fourth area 403.

If it is identified that the third area with the enlarged size is displayable within the fourth area, the processor 130 may control the display 110 such that the third area with the enlarged size is displayed in the fourth area in the step S304.

For example, referring to FIG. 4C, the processor 130 may control the display 110 such that the third area 405 with the enlarged size is displayed in the margin area on the right side wherein the third area 405 with the enlarged size can be included in the fourth area. Here, the enlarged size of the third area may be determined to correspond to at least one of the horizontal length or the vertical length of the fourth area, or set by the user, or may be a value determined as the default. As in FIG. 4C, if it is identified that the third area 405 with the enlarged size is displayable within the fourth area 403, the processor 130 may display the third area 405 with the enlarged size in the fourth area 403 such that the center of the third area 405 with the enlarged size is aligned with the center of the third area 401 included in the first area. For example, as in FIG. 4C, in case the third area 405 with the enlarged size is arranged on the right side of the third area 401, the processor 130 may display the third area 405 with the enlarged size in the fourth area 403 such that the center of the third area 405 with the enlarged size is arranged on the same horizontal line with the center of the third area 401.

An embodiment wherein, if it is identified that the third area with the enlarged size is not displayable within the fourth area, the processor 130 displays the third area with the enlarged size in at least a partial area of the third area and at least a partial area of the fourth area will be explained with reference to FIG. 5A to FIG. 5C.

Referring to FIG. 5A, the processor 130 may control the display 110 to display a first area 12 including a content and a second area 22 corresponding to a margin area wherein the content is not displayed.

If a third area 501 including a portion of the content to be enlarged and displayed is selected in the first area 12, the processor 130 may identify a fourth area adjacent to the third area in the second area 22. For example, the processor 130 may identify a fourth area 503 adjacent to the third area 501 in the second area 22 wherein the content is not displayed. As in FIG. 5B, in case a part wherein the third area 501 and the second area 22 are adjacent is the margin on the right side and the lower side of the display 110, the processor 130 may identify the margin on the right side and the lower side of the display 110 as the fourth area 503.

The processor 130 may identify whether the third area with an enlarged size is displayable within the identified fourth area 503.

In case the same size as the third area 501 can be included in the fourth area 503, the processor 130 may identify that the third area with the enlarged size is displayable in the fourth area 503.

As in FIG. 5B, in case at least one of the horizontal length or the vertical length of the fourth area 503 is identical to or smaller than at least one of the horizontal length or the vertical length of the third area 501, the processor 130 may identify that the third area with the enlarged size cannot be displayed in the fourth area 503.

The processor 130 may identify whether the third area with the enlarged size is not displayable within the fourth area 503, but is displayable in at least a partial area of the third area 501 and at least a partial area of the fourth area 503 in the step S305. The processor 130 may identify that the third area with the enlarged size is displayable across the overall area including at least a partial area of the third area 501 and at least a partial area of the fourth area 503. If it is identified that the third area with the enlarged size is displayable in at least a partial area of the third area 501 and at least a partial area of the fourth area 503, the processor 130 may display the third area with the enlarged size in the area including at least the partial area of the third area 501 and at least the partial area of the fourth area 503. For example, as illustrated in FIG. 5C, the processor 130 may control the display 110 such that the third area with the enlarged size is enlarged in a form of extending from the third area 501 within the first area to at least the partial area of the fourth area 503, and is displayed.

For example, the processor 130 may display the third area 505 with the enlarged size to include the entire area of the third area 501 and a partial area of the fourth area 503. In case the fourth area 503 adjacent to the third area 501 was identified on the right side and the lower side the processor 130 may display the third area 505 with the enlarged size such that the upper left end of the third area 505 with the enlarged size corresponds to the third area 501.

An embodiment of displaying the third area with the enlarged size in case it was identified that the third area with the enlarged size is not displayable within the fourth area, and is not displayable in at least a partial area of the third area and at least a partial area of the fourth area will be explained with reference to FIG. 6A to FIG. 6C.

Referring to FIG. 6A, the processor 130 may control the display 110 to display a first area 13 including a content and a second area 23 corresponding to a margin area wherein the content is not displayed.

If a third area 601 including a portion of the content to be enlarged and displayed is selected in the first area 13, the processor 130 may identify a fourth area 603 adjacent to the third area 601 in the second area 23. For example, the processor 130 may identify a fourth area 603 adjacent to the third area 601 in the second area 23 wherein the content is not displayed. As in FIG. 6B, in case a part wherein the third area 601 and the second area 23 are adjacent is the margin on the lower side of the display 110, the processor 130 may identify the margin on the lower side of the display 110 as the fourth area 603.

The processor 130 may identify whether the third area with an enlarged size is displayable within the identified fourth area 603.

In case the same size as the third area 601 can be included in the fourth area 603, the processor 130 may identify that the third area with the enlarged size is displayable in the fourth area 603.

As in FIG. 6B, in case at least one of the horizontal length or the vertical length of the fourth area 603 is identical to or smaller than at least one of the horizontal length or the vertical length of the third area 601, the processor 130 may identify that the third area with the enlarged size cannot be displayed in the fourth area 603.

Afterwards, the processor 130 may identify whether the third area with the enlarged size is not displayable within the fourth area 603, but is displayable in at least a partial area of the third area 601 and at least a partial area of the fourth area 603.

As in FIG. 6B, if it is identified that the third area with the enlarged size is not displayable within the fourth area 603, and is not displayable in at least a partial area of the third area 601 and at least a partial area of the fourth area 603, the processor 130 may identify a fifth area 605 not adjacent to the third area 603 in the second area 23 in the step S307. For example, referring to FIG. 6B, the fourth area 603 adjacent to the third area 601 may be located on the lower side of the third area 601. The processor 130 may identify the left area and the upper area in the second area 23 not adjacent to the third area 601 as the fifth area 605.

The processor 130 may identify whether the third area with the enlarged size is displayable within the identified fifth area in the step S308.

Referring to FIG. 6B, the processor 130 may identify whether the third area with the enlarged size is displayable within the left area and the upper area identified as the fifth area 605.

If it is identified that the third area with the enlarged size is displayable within the fifth area, the processor 130 may move the first area in a direction of the fifth area, and control the display 110 to display the third area with the enlarged size within the fifth area as the first area is moved in the step S309.

For example, if it is identified that the third area with the enlarged size is displayable within the fifth area 605, the processor 130 may move the first area 13 in the direction of the fifth area and display it. The processor 130 may control the display 110 to display the third area with the enlarged size within the fourth area with the enlarged size according to the moved first area.

If it is identified that the third area with the enlarged size is not displayable within the fifth area, the processor 130 may identify whether the third area with the enlarged size is displayable in at least a partial area of the fourth area with the enlarged size as the first area is moved to the direction of the fifth area and at least the partial area of the third area in the step S310.

Here, if it is identified that the third area with the enlarged size is displayable in at least the partial area of the fourth area with the enlarged size as the first area is moved to the direction of the fifth area and at least the partial area of the third area, the processor 130 may move the first area to the direction of the fifth area, and control the display 110 to display the third area with the enlarged size in at least the partial area of the fourth area with the enlarged size as the first area moved and at least the partial area of the third area in the step S311. For example, referring to FIG. 6C, the processor 130 may move the first area 13 in the direction of the fifth area, and display the moved first area 13′ on the display. The processor 130 may control the display 110 to display the third area 607 with the enlarged size in at least the partial area of the fourth area with the enlarged size by the moved first area 13′ and at least the partial area of the third area.

An embodiment of displaying the third area with the enlarged size in case it was identified that the third area with the enlarged size is not displayable within the fifth area, and is not displayable in at least a partial area of the fourth area with an enlarged size by the moved first area and at least a partial area of the moved third area will be explained with reference to FIG. 7A to FIG. 7C.

Referring to FIG. 7A, the processor 130 may control the display 110 to display a first area 14 including a content. The processor 130 may control the display 110 to display a second area 24 corresponding to a margin area wherein the content is not displayed.

If a third area 701 including a portion of the content to be enlarged and displayed is selected in the first area 14, the processor 130 may identify a fourth area 703 adjacent to the third area 701 in the second area 24. As in FIG. 7B, in case a part wherein the third area 701 and the second area 24 are adjacent is the margin on the right side and the lower side of the display 110, the processor 130 may identify the margin on the right side and the lower side of the display 110 as the fourth area 703.

The processor 130 may identify whether the third area with an enlarged size is displayable within the identified fourth area 703.

Afterwards, if it is identified that the third area with the enlarged size is not displayable within the fourth area 703, the processor 130 may identify whether the third area with the enlarged size is displayable in at least a partial area of the third area 701 and at least a partial area of the fourth area 703.

As in FIG. 6B, if it is identified that the third area with the enlarged size is not displayable within the fourth area 703, and is not displayable in at least the partial area of the third area 701 and at least the partial area of the fourth area 703, the processor 130 may identify a fifth area 705 not adjacent to the third area 701 in the second area 24.

Referring to FIG. 7B, the processor 130 may identify the right area in the second area 24 not adjacent to the third area 701 as the fifth area 705.

The processor 130 may identify whether the third area with the enlarged size is displayable within the identified fifth area.

Here, if it is identified that the third area with the enlarged size is not displayable within the fifth area, the processor 130 may identify whether the third area with the enlarged size is displayable in at least the partial area of the fourth area with an enlarged size as the first area is moved to the direction of the fifth area and at least the partial area of the third area.

Here, if it is identified that the third area with the enlarged size is not displayable in at least the partial area of the fourth area with the enlarged size as the first area is moved in the direction of the fifth area and at least the partial area of the third area, the processor 130 may control the display 110 to provide a UI for selecting at least one of the enlarged size or a display area of the third area in the step S312.

The processor 130 may provide a UI for receiving an input of a user selection related to the enlarged size of the third area with the enlarged size. Here, the enlarged horizontal length and the enlarged vertical length for the third area may be selected differently. The ratio of the enlarged horizontal length and the enlarged vertical length for the third area may be made to be identical.

A UI for receiving an input of a user selection related to the display area of the third area with the enlarged size may be provided. Here, the selected display area may be the central coordinate of the third area with the enlarged size.

The processor 130 may control the display 110 to display the third area with the enlarged size based on at least one of the enlarged size or the display area of the third area selected through the UI in the step S313.

For example, if the central coordinate of the display area is selected as (500, 500), the processor 130 may enlarge the third area according to the selected enlarged size, and control the display 110 to display the third area with the enlarged size such that the central coordinate of the third area with the enlarged size becomes (500, 500).

Referring to FIG. 7C, when the enlarged size or the display area of the third area is selected through the UI, the processor 130 may display the third area 707 with the enlarged size to be overlapped with a portion of the first area 14 other than the third area. In case the third area with the enlarged size is displayed, even if the first area 14 including the content is displayed to be partially overlapped other than the third area 701 that will be enlarged and displayed, the third area 701 may be enlarged and displayed.

According to an embodiment, as illustrated in FIG. 8A, a plurality of content areas 801, 803 that will be enlarged and displayed may be selected in the first area 15. For example, if a plurality of third areas 801, 803 respectively including a portion of a content to be enlarged and displayed are selected in the first area 15, the processor 130 may identify a plurality of fourth areas adjacent to each of the plurality of third areas in the second area 25.

Referring to FIG. 8B, the processor 130 may control the display 110 to display each of a plurality of third areas 805, 807 with the enlarged sizes within the plurality of identified fourth areas. For example, the processor 130 may identify a plurality of fourth areas that are closest to each of the identified third areas 801, 803, and display each of the plurality of third areas 805, 807 with the enlarged sizes.

In case the plurality of third areas 805, 807 with the enlarged sizes are displayed, the processor 130 may identify whether the plurality of third areas 805, 807 with the enlarged sizes can be displayed within the fourth areas, and control the display 110 such that the plurality of third areas 805, 807 are displayed in at least a partial area of the plurality of third areas 801, 803 and at least a partial area of the plurality of fourth areas.

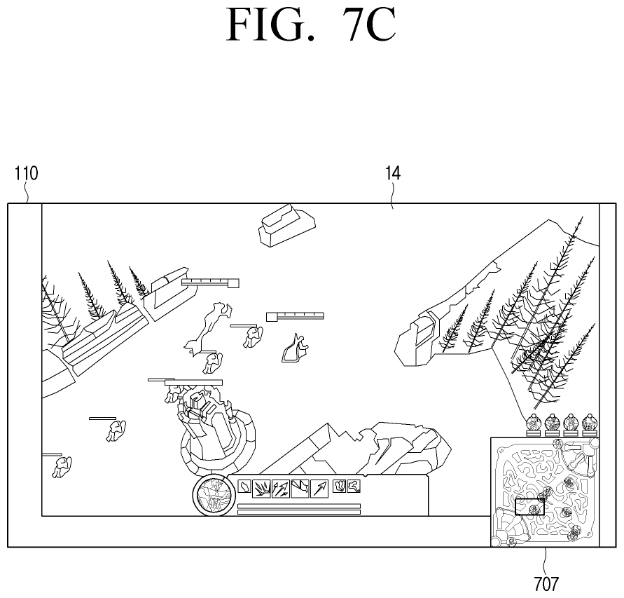

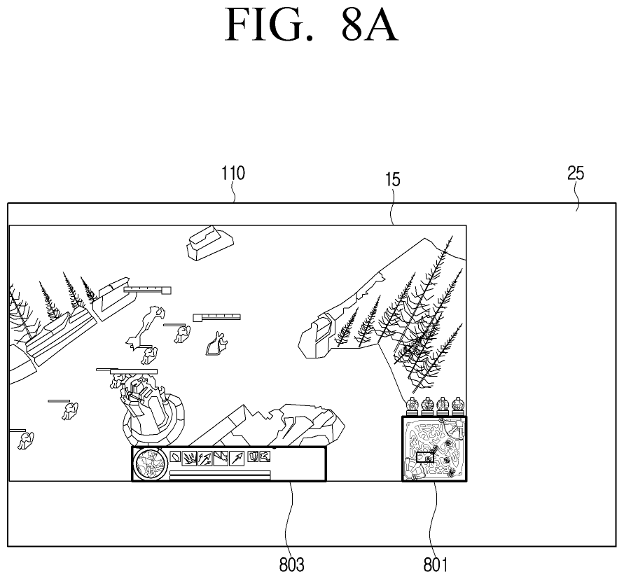

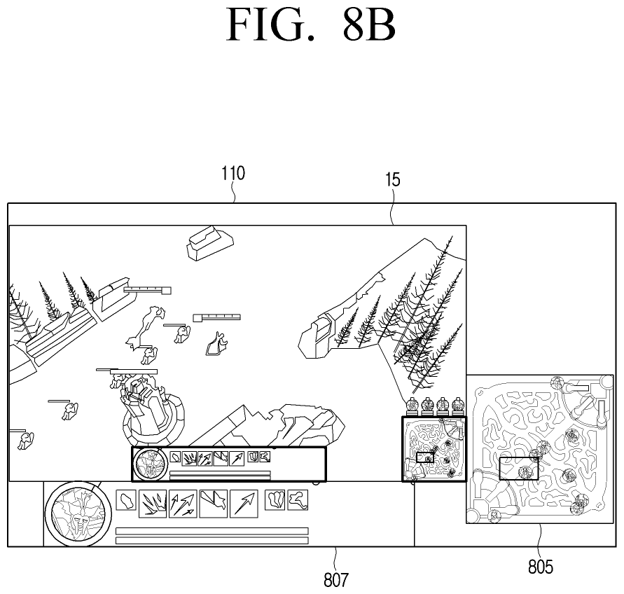

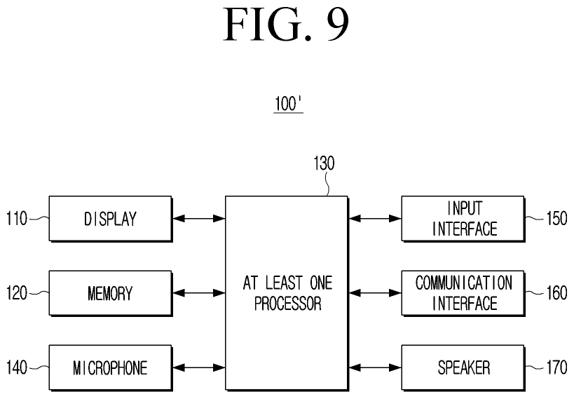

FIG. 9 is a block diagram illustrating a detailed configuration of an electronic device according to an embodiment of the disclosure.

Referring to FIG. 9, the electronic device 100′ may include a display 110, memory 120, at least one processor 130, a microphone 140, an input interface 150, a communication interface 160, and a speaker 170. For additional implementation details, reference may be made to the descriptions of FIG. 2.

The microphone 140 is a component for receiving an input of a user voice or other sounds, and converting them into audio data. According to another embodiment, the electronic device 100′ may receive a user voice input through an external device through the communication interface 160.

The input interface 150 includes circuitry, and may receive an input of a user instruction for setting or selecting various types of functions supported in the electronic device 100′. For this, the input interface 150 may include a plurality of buttons, and may be implemented as a touch screen that can simultaneously perform the function of the display.

The processor 130 may control operations of the electronic device 100′ based on a user instruction input through the input interface 150. For example, the processor 130 may control the electronic device 100′ based on an on/off instruction of the electronic device 100′, an on/off instruction of the functions of the electronic device 100′, for example, input through the input interface 150.

The communication interface 160 performs communication with an external device, and receives inputs of various types of data and information. For example, the communication interface 160 may receive inputs of various types of data, or information, for example, from a home appliance (a display device, an air conditioner, or an air purifier, for example), an external storage medium (e.g., a USB memory), or an external server (e.g., a webhard), for example, through communication methods such as Wi-Fi based on AP (Wi-Fi, a wireless LAN network), Bluetooth, Zigbee, a wired/wireless local area network (LAN), a wide area network (WAN), Ethernet, IEEE 1394, a high-definition multimedia interface (HDMI), a universal serial bus (USB), a mobile high-definition link (MHL), Audio Engineering Society/European Broadcasting Union (AES/EBU), optical, or coaxial, for example. The electronic device 100′ may communicate with an air conditioner through the communication interface 160.

The speaker 170 may be a component that outputs not only various types of audio data but also various types of notification sounds or voice messages, for example. The processor 130 may control the speaker 170 to output feedbacks or various types of notifications according to the various embodiments of the disclosure in audio forms.

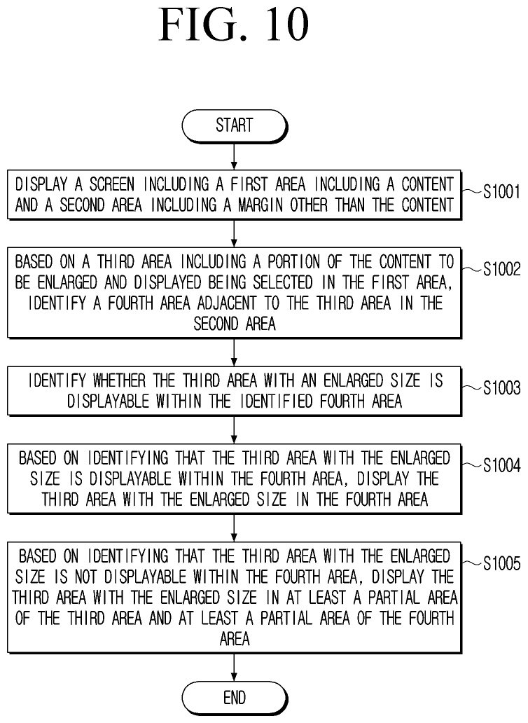

FIG. 10 is a flow chart for illustrating a control method of an electronic device according to an embodiment of the disclosure.

A screen including a first area including a content and a second area including a margin other than the content may be displayed in the step S1001.

If a third area including a portion of the content to be enlarged and displayed is selected in the first area, a fourth area adjacent to the third area may be identified in the second area in the step S1002.

It may be identified whether the third area with an enlarged size is displayable within the identified fourth area in the step S1003.

Afterwards, if it is identified that the third area with the enlarged size is displayable within the fourth area, the third area with the enlarged size may be displayed in the fourth area in the step S1004.

If it is identified that the third area with the enlarged size is not displayable within the fourth area, the third area with the enlarged size may be displayed in at least a partial area of the third area and at least a partial area of the fourth area in the step S1005.

If it is identified that the third area with the enlarged size is not displayable within the fourth area, and is not displayable in at least the partial area of the third area and at least the partial area of the fourth area, a fifth area not adjacent to the third area may be identified in the second area.

It may be identified whether the third area with the enlarged size is displayable within the identified fifth area.

If it is identified that the third area with the enlarged size is displayable within the fifth area, the first area may be moved in a direction of the fifth area, and the third area with the enlarged size may be displayed within the fifth area, as the first area is moved.

If it is identified that the third area with the enlarged size is not displayable within the fifth area, and it is identified that the third area with the enlarged size is displayable in at least the partial area of the fourth area with the enlarged size as the first area is moved to the direction of the fifth area and at least the partial area of the third area, the first area may be moved to the direction of the fifth area, and the third area with the enlarged size may be displayed in at least the partial area of the fourth area with the enlarged size as the first area moved and at least the partial area of the third area.

If it is identified that the third area with the enlarged size is not displayable within the fourth area, and it is identified that the third area with the enlarged size is not displayable in at least the partial area of the fourth area with the enlarged size as the first area is moved to the direction of the fifth area and at least the partial area of the third area, a UI for selecting at least one of the enlarged size or a display area of the third area may be provided.

The third area with the enlarged size may be displayed based on at least one of the enlarged size or the display area of the third area selected through the UI.

The third area may be a rectangular area having a predetermined ratio, and the third area with the enlarged size may be an area that was enlarged while the predetermined ratio is maintained.

In the step S1004, if it is identified that the third area with the enlarged size is displayable within the fourth area, the third area with the enlarged size may be displayed in the fourth area such that the center of the third area with the enlarged size is aligned with the center of the third area included in the first area.

In the step S1005, if it is identified that the third area with the enlarged size is not displayable within the fourth area, the third area with the enlarged size may be enlarged in a form of extending from the third area within the first area to at least the partial area of the fourth area, and may be displayed.

If a plurality of third areas respectively including a portion of the content to be enlarged and displayed are selected in the first area, a plurality of fourth areas adjacent to each of the plurality of third areas may be identified in the second area.

Each of the plurality of third areas with the enlarged sizes may be displayed within the plurality of identified fourth areas.

According to an embodiment of the disclosure, the various embodiments may be implemented as software including instructions stored in machine-readable storage media, which can be read by machines (e.g.: computers). The machines refer to devices that call instructions stored in a storage medium, and can operate according to the called instructions, and the devices may include a device according to the embodiments. In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘a non-transitory storage medium’ only means that a storage medium is a tangible device, and does not include signals (e.g.: electromagnetic waves), and the term does not distinguish a case wherein data is stored in the storage medium semi-permanently and a case wherein data is stored temporarily. For example, ‘a non-transitory storage medium’ may include a buffer wherein data is temporarily stored.

According to an embodiment, the method according to the various embodiments disclosed herein may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or distributed on-line (e.g.: download or upload) through an application store (e.g.: Play Store™M) or directly between two user devices (e.g.: smartphones). In the case of on-line distribution, at least a portion of a computer program product (e.g.: a downloadable app) may be stored in a storage medium that is readable by machines such as the server of the manufacturer, the server of the application store, and the memory of the relay server at least temporarily, or may be generated temporarily.

While embodiments of the disclosure have been shown and described, the disclosure is not limited to the embodiments, and it is apparent that various modifications may be made by those having ordinary skill in the technical field to which the disclosure belongs, without departing from the gist of the disclosure as claimed by the appended claims. It is intended that such modifications are not to be interpreted independently from the technical idea or prospect of the disclosure.

What is claimed is:

1. An electronic device comprising:
a display;
memory storing at least one instruction; and
at least one processor,
wherein the at least one instruction, when executed by the at least one processor individually or collectively, causes the electronic device to:
control the display to display a screen including a first area including content and a second area including a margin other than the content;
based on a third area including a portion of the content to be enlarged and displayed being selected in the first area, identify a fourth area adjacent to the third area in the second area;
identify whether the third area with an enlarged size is displayable within the fourth area;
based on identifying that the third area with the enlarged size is displayable within the fourth area, control the display such that the third area with the enlarged size is displayed in the fourth area; and
based on identifying that the third area with the enlarged size is not displayable within the fourth area, control the display such that the third area with the enlarged size is displayed in at least a partial area of the third area and at least a partial area of the fourth area.

2. The electronic device of claim 1, wherein the at least one instruction, when executed by the at least one processor individually or collectively, causes the electronic device to:
based on identifying that the third area with the enlarged size is not displayable within (i) the fourth area, (ii) at least the partial area of the third area, and (iii) at least the partial area of the fourth area:
identify a fifth area not adjacent to the third area in the second area;
identify whether the third area with the enlarged size is displayable within the fifth area; and
based on identifying that the third area with the enlarged size is displayable within the fifth area, move the first area to the direction of the fifth area, and control the display to display the third area with the enlarged size within the fourth area with an enlarged size as the first area moved.

3. The electronic device of claim 2, wherein the at least one instruction, when executed by the at least one processor individually or collectively, causes the electronic device to:
based on identifying, that the third area with the enlarged size is not displayable within the fifth area, and based on identifying that the third area with the enlarged size is displayable in at least a partial area of the fourth area with the enlarged size as the first area is moved and at least the partial area of the third area, move the first area to the direction of the fifth area, and control the display to display the third area with the enlarged size in at least the partial area of the fourth area with the enlarged size as the first area moved and at least the partial area of the third area.

4. The electronic device of claim 2, wherein the at least one instruction, when executed by the at least one processor individually or collectively, causes the electronic device to:
based on identifying that the third area with the enlarged size is not displayable within the fourth area, and based on identifying that the third area with the enlarged size is not displayable in at least a partial area of the fourth area with the enlarged size as the first area is moved by moving the first area to the direction of the fifth area and at least the partial area of the third area,
control the display to provide a user interface (UI) for selecting at least one from among an enlarged size and a display area of the third area; and
control the display to display the third area with the enlarged size based on a user selection via the UI.

5. The electronic device of claim 1,
wherein the third area is a rectangular area having a predetermined ratio between dimensions, and
wherein the third area with the enlarged size maintains the predetermined ratio between dimensions.

6. The electronic device of claim 1, wherein the at least one instruction, when executed by the at least one processor individually or collectively, causes the electronic device to:
based on identifying that the third area with the enlarged size is displayable within the fourth area, display the third area with the enlarged size in the fourth area such that a center of the third area with the enlarged size is aligned with a center of the third area included in the first area.

7. The electronic device of claim 1, wherein the at least one instruction, when executed by the at least one processor individually or collectively, causes the electronic device to:
based on identifying that the third area with the enlarged size is not displayable within the fourth area, control the display such that the third area with the enlarged size is displayed to extend from the third area within the first area to at least the partial area of the fourth area.

8. The electronic device of claim 1, wherein the at least one instruction, when executed by the at least one processor individually or collectively, causes the electronic device to:
based on a plurality of third areas being selected in the first area, wherein portions of the content to be enlarged and displayed are included among the plurality of third areas, identify a plurality of fourth areas adjacent to the plurality of third areas in the second area; and
control the display to display the plurality of third areas with enlarged sizes within the plurality of fourth areas.

9. A control method of an electronic device, the control method comprising:
displaying a screen including a first area including a content and a second area including a margin other than the content;
based on a third area including a portion of the content to be enlarged and displayed being selected in the first area, identifying a fourth area adjacent to the third area in the second area;
identifying whether the third area with an enlarged size is displayable within the fourth area;
based on identifying that the third area with the enlarged size is displayable within the fourth area, displaying the third area with the enlarged size in the fourth area; and
based on identifying that the third area with the enlarged size is not displayable within the fourth area, displaying the third area with the enlarged size in at least a partial area of the third area and at least a partial area of the fourth area.

10. The control method of claim 9, further comprising:
based on identifying that the third area with the enlarged size is not displayable within (i) the fourth area, (ii) at least the partial area of the third area, and (iii) at least the partial area of the fourth area:
identifying a fifth area not adjacent to the third area in the second area;
identifying whether the third area with the enlarged size is displayable within the fifth area; and
based on identifying that the third area with the enlarged size is displayable within the fifth area, moving the first area to the direction of the fifth area, and displaying the third area with the enlarged size within the fourth area with an enlarged size as the first area moved.

11. The control method of claim 10, further comprising:
based on identifying that the third area with the enlarged size is not displayable within the fifth area, and based on identifying that the third area with the enlarged size is displayable in at least a partial area of the fourth area with the enlarged size as the first area is moved to the direction of the fifth area and at least the partial area of the third area, moving the first area to the direction of the fifth area, and displaying the third area with the enlarged size in at least the partial area of the fourth area with the enlarged size as the first area moved and at least the partial area of the third area.

12. The control method of claim 10, further comprising:
based on identifying that the third area with the enlarged size is not displayable within the fourth area, and based on identifying that the third area with the enlarged size is not displayable in at least a partial area of the fourth area with the enlarged size as the first area is moved to the direction of the fifth area and at least the partial area of the third area:
providing a user interface (UI) for selecting at least one from among the enlarged size and a display area of the third area; and
displaying the third area with the enlarged size based on a user selection via the UI.

13. The control method of claim 9, wherein the third area is a rectangular area having a predetermined ratio between dimensions, and
wherein the third area with the enlarged size is maintains the predetermined ratio between dimensions.

14. The control method of claim 9, wherein the displaying the third area with the enlarged size in the fourth area comprises:
based on identifying that the third area with the enlarged size is displayable within the fourth area, displaying the third area with the enlarged size in the fourth area such that a center of the third area with the enlarged size is aligned with a center of the third area included in the first area.

15. The control method of claim 9, wherein the displaying the third area with the enlarged size in the fourth area comprises:
based on a plurality of third areas being selected in the first area, wherein portions of the content to be enlarged and displayed are included among the plurality of third areas, identifying a plurality of fourth areas adjacent to the plurality of third areas in the second area; and
displaying the plurality of third areas with enlarged sizes within the plurality of fourth areas.

16. A non-transitory computer-readable medium having at least one instruction recorded thereon, that, when executed by at least one processor individually or collectively, causes the at least one processor to:
display a screen including a first area including a content and a second area including a margin other than the content;
based on a third area including a portion of the content to be enlarged and displayed being selected in the first area, identify a fourth area adjacent to the third area in the second area;
identify whether the third area with an enlarged size is displayable within the fourth area;
based on identifying that the third area with the enlarged size is displayable within the fourth area, display the third area with the enlarged size in the fourth area; and
based on identifying that the third area with the enlarged size is not displayable within the fourth area, display the third area with the enlarged size in at least a partial area of the third area and at least a partial area of the fourth area.

17. The non-transitory computer readable medium of claim 16, wherein the at least one instruction, when executed by at least one processor individually or collectively, causes the at least one processor to:
based on identifying that the third area with the enlarged size is not displayable within (i) the fourth area, (ii) at least the partial area of the third area, and (iii) at least the partial area of the fourth area:
identifying a fifth area not adjacent to the third area in the second area;
identifying whether the third area with the enlarged size is displayable within the fifth area; and
based on identifying that the third area with the enlarged size is displayable within the fifth area, moving the first area to the direction of the fifth area, and displaying the third area with the enlarged size within the fourth area with an enlarged size as the first area moved.

18. The non-transitory computer readable medium of claim 17, wherein the at least one instruction, when executed by at least one processor individually or collectively, causes the at least one processor to:
based on identifying that the third area with the enlarged size is not displayable within the fifth area, and based on identifying that the third area with the enlarged size is displayable in at least a partial area of the fourth area with the enlarged size as the first area is moved to the direction of the fifth area and at least the partial area of the third area, moving the first area to the direction of the fifth area, and displaying the third area with the enlarged size in at least the partial area of the fourth area with the enlarged size as the first area moved and at least the partial area of the third area.

19. The non-transitory computer readable medium of claim 17, wherein the at least one instruction, when executed by at least one processor individually or collectively, causes the at least one processor to:
based on identifying that the third area with the enlarged size is not displayable within the fourth area, and based on identifying that the third area with the enlarged size is not displayable in at least a partial area of the fourth area with the enlarged size as the first area is moved to the direction of the fifth area and at least the partial area of the third area:
providing a user interface (UI) for selecting at least one from among the enlarged size and a display area of the third area; and
displaying the third area with the enlarged size based on a user selection via the UI.

20. The non-transitory computer readable medium of claim 16,
wherein the third area is a rectangular area having a predetermined ratio between dimensions, and
wherein the third area with the enlarged size is maintains the predetermined ratio between dimensions.
